(19) United States
(12) Patent Application Publication
(10) Pub. No.: US 2013/0027360 A1
(43) Pub. Date: Jan. 31, 2013

(54) POSITIONING AND CALIBRATION METHOD

(71) Applicants: Jar-Ferr Yang, Tainan City (TW); Chi-Kun Lin, Tainan City (TW); Cheng-Mao Li, Tainan City (TW)

(72) Inventors: Jar-Ferr Yang, Tainan City (TW); Chi-Kun Lin, Tainan City (TW); Cheng-Mao Li, Tainan City (TW)

(21) Appl. No.: 13/557,865

(22) Filed: Jul. 25, 2012

(30) Foreign Application Priority Data
Jul. 26, 2011 (TW) 100126400

(51) Int. Cl. G06F 3/041

(52) U.S. Cl. 345/178

(57) ABSTRACT

A positioning and calibration method is applied in the positioning and calibration of a projection system with touch control function. The projection system includes a touch device and a projection device. The touch device has touch plates, which can be combined and formed into a plane. The projection device has projection units, which project images onto projection areas of the plane, respectively, so as to form a projection image on the plane. The positioning and calibration method includes the steps of projecting positioning markers onto the plane by the projection device; disposing a calibration element at or around each of the positioning markers; and locating and calibrating the corresponding projection unit according to a positioning signal of the calibration element delivered by the touch device. The invention makes the projection system, having touch plates, projection units and the touch control function, have the good location function.

### CROSS REFERENCE TO RELATED APPLICATIONS

This Non-provisional application claims priority under 35 U.S.C. §119(a) on Patent Application No(s). 100126400 filed in Taiwan, Republic of China on Jul. 26, 2011, the entire contents of which are hereby incorporated by reference.

### BACKGROUND OF THE INVENTION

1. Field of Invention

The invention relates to a projection system with touch control function, in which touch plates are combinable.

2. Related Art

In an interactive projection system with touch control function, the projection technology and the touch technology are combined such that the projection image can be correspondingly changed when the user touches the projection image projected onto the touch device, and the interactive effect with the user can be generated. As shown in FIG. 1, the conventional projection technology and touch technology are combined and applied to the restaurant order in an actual example.

Referring to FIG. 1, a touch projection device 1 (i.e., an interactive electronic order system) includes a dining table device 11, an order computer host 12 and a projector 13. The order computer host 12 is electrically connected to the dining table device 11 and the projector 13. A touch panel 111 is disposed on a desktop of the dining table device 11. In addition, the order computer host 12 can deliver the meal information of the restaurant to the projector 13, and the projector 13 can project the meal information onto the touch panel 111 of the dining table device 11. The customer can perform the operations, such as ordering, querying, calling the service personnel or checking out, according to the projection information displayed on the touch panel 111. Thus, the touch projection device 1 can provide the customer the effective interactive order function.

The projector 13 of the touch projection device 1 only can project the order information onto one touch panel 111 of one dining table device 11, so that the area, which can be touched by and interacted with the user, is relatively restricted. When more users want to perform the interactive touch in a large area place, plural touch panels 111 have to be adopted for the combination, and more corresponding projectors 13 have to be used concurrently to project plural sets of projection images so that a complete projection image with the large area can be formed by way of combination.

However, the prior art cannot directly use plural touch projection devices 1 to form a projection system with touch control function by way of combination to achieve the large-area touch interaction requirement. One main reason is that the order computer host 12 only can control one single touch panel 111 and one single projector 13, the combination of the plural touch panels 111 does not link with the plural projectors 13, and the order computer host 12 cannot integrate all the touch panels 111 and projectors 13. Another important reason is that the corresponding relationships between the plural touch panels 111 and the projection images projected by all the projectors 13 are not established. In other words, no corresponding positioning is present between the large-area projection image, formed by combining the images projected by the plural projectors 13, and the touch panels 111, so that the large-area interactive function cannot be obtained.

Therefore, it is an important subject to provide a positioning and calibration method applied to a touch projection system having plural touch plates, plural projection units and the good location function.

### SUMMARY OF THE INVENTION

In view of the foregoing subject, an objective of the invention is to provide a positioning and calibration method applied to a touch projection system having plural touch plates, plural projection units and the good location function.

To achieve the above objective, the present invention discloses a positioning and calibration method that is applied in the positioning and calibration of a projection system with touch control function. The projection system includes a touch device and a projection device. The touch device has touch plates, which can be combined and formed into a plane. The projection device has projection units, which project images onto projection areas of the plane, respectively, so as to form a projection image on the plane. The positioning and calibration method includes the steps of: projecting positioning markers onto the plane by the projection device; disposing a calibration element at or around each of the positioning markers; and locating and calibrating the corresponding projection unit according to a positioning signal of the calibration element delivered by the touch device. The invention makes the projection system, having touch plates, projection units and the touch control function, have the good location function.

In one embodiment, in the step of projecting the positioning markers, one of the projection units projects the positioning markers alternately.

In one embodiment, in the step of projecting the positioning markers, the projection units project the positioning markers concurrently.

In one embodiment, the positioning markers are located at corners of the projection area, respectively.

In one embodiment, at least one of the positioning markers is located at a middle position of the projection area.

In one embodiment, the positioning markers are located at middle positions of the projection areas, respectively.

In one embodiment, the positioning markers are located within the projection areas, respectively.

In one embodiment, the method further includes the step of grounding the calibration element.

In one embodiment, the calibration element is a metal conductor.

In one embodiment, the touch plates may be combined on a ground, a wall or a desktop to form the plane.

As mentioned above, the positioning and calibration method according to the invention includes the steps of projecting plural positioning markers on the plane by the projection device; disposing a calibration element at or around each positioning marker; and locating and calibrating the corresponding projection unit according to a positioning signal of the calibration element delivered by the touch device. Thus, the location can be positioned according to the positioning signal corresponding to the display position of the projection image, so that the actual position of the touch plate on the projection area matches with the display position of the projection image to complete the positioning and calibrating operations. Therefore, the positioning and calibration method of the invention makes a touch projection system, having plural touch plates and plural projection units, have the good location function.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a projection system with touch control function;

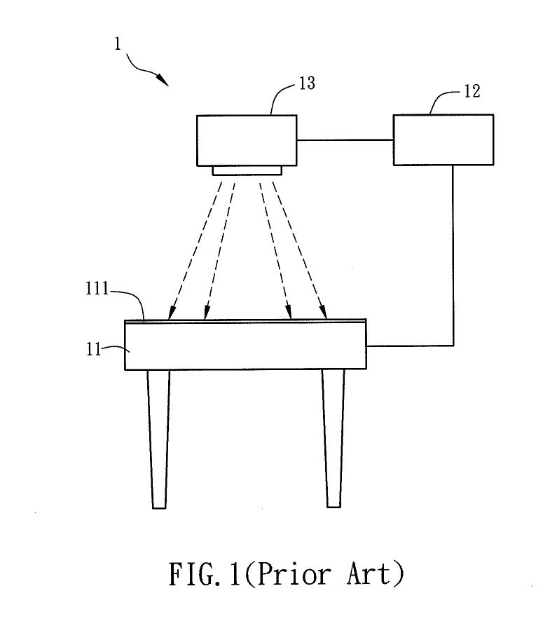

FIG. 2 is a schematic illustration showing processes of a positioning and calibration method according to a preferred embodiment of the invention;

FIG. 3A is a schematic illustration showing a projection system, which has touch control function and is applied to the positioning and calibration method of FIG. 2;

FIG. 3B is a schematic illustration showing four sub-projection images combined together to form a complete projection image;

FIG. 4A is a schematic illustration showing an image divided into plural sub-images;

FIG. 4B is a schematic illustration showing the projection areas of the projection system of FIG. 3A corresponding to the touch plates; and

FIGS. 5A to 5B and 6A to 6B are schematic illustrations showing the projection unit projecting positioning markers on the projection areas, respectively.

### DETAILED DESCRIPTION OF THE INVENTION

The present invention will be apparent from the following detailed description, which proceeds with reference to the accompanying drawings, wherein the same references relate to the same elements.

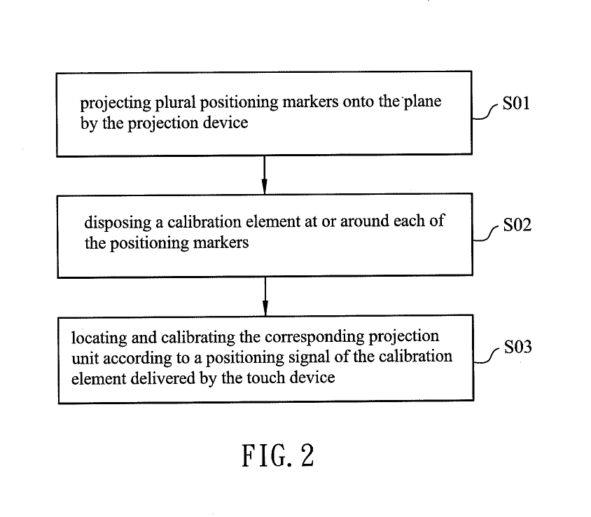

FIG. 2 is a schematic illustration showing processes of a positioning and calibration method according to a preferred embodiment of the invention. As shown in FIG. 2, a positioning and calibration method of the invention is applied in the positioning and calibrating operations of a projection system with touch control function (also referred to as a touch projection system). The touch projection system can combine plural touch plates together and may be applied to a large-area ground, wall or desktop, so that the user can interact with the projection image projected onto the large-area ground, wall or desktop by touching the projection image.

Referring to FIG. 2, the positioning and calibration method of the invention includes steps S01 to S03. In the step S01, plural positioning markers are projected onto a plane by the projection device. In the step S01, a calibration element is disposed at or around each of the positioning markers. In the step S03, the corresponding projection unit is located and calibrated according to a positioning signal of the calibration element delivered by the touch device.

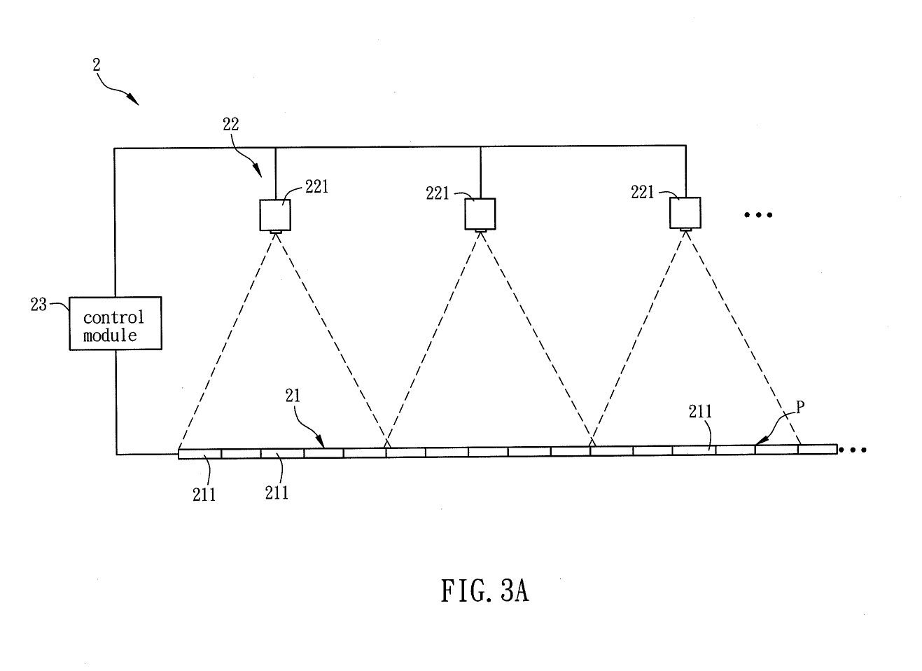

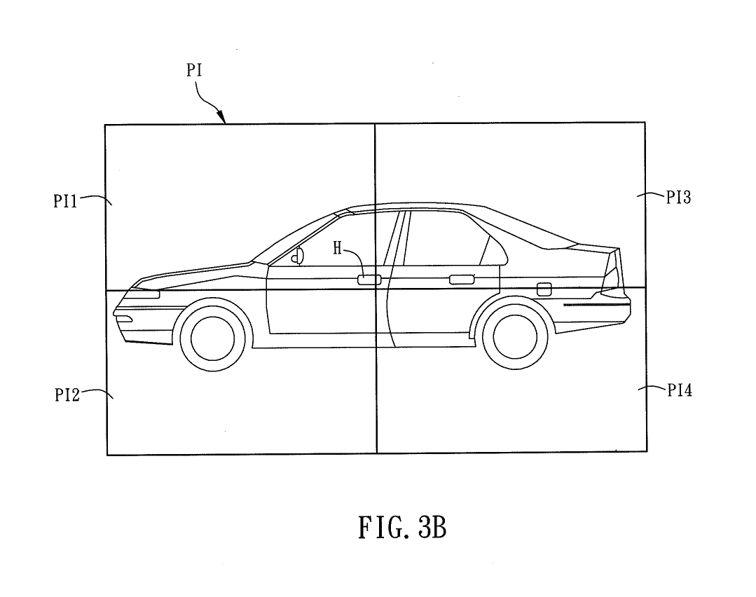

In the following, the touch projection system 2 using the positioning and calibration method of FIG. 2 will be described with referent to FIG. 3A.

Referring to FIG. 3A, the touch projection system 2 includes a touch device 21, a projection device 22 and a control module 23.

The touch device 21 has plural touch plates 211, which can be combined and formed into a plane P. The touch plates 211 may be electrically connected to each other, and may be combined and formed into a complete plane P on a large-area ground, wall or desktop. In the example of FIG. 3A, the plural touch plates 211 are combined and formed into a complete plane P on the ground. Of course, the invention is not restricted thereto. The user may also combine the touch plates 211 into a large-area plane P with the touch function on the wall, the desktop or any other place.

In this example, the touch plate 211 is a capacitive touch panel. The capacitive touch panel has the dustproof advantage, the fireproof advantage, the scratch proof advantage, the strong and durable advantage, the high resolution advantage and the like. Because the human body is a conductor, when the human body contacts the capacitive touch plates, the weak leakage current in the human body changes the voltage level of the touch panel capacitor. The capacitive touch panel can calculate the touched coordinate position according to its variation. The touch projection system 2 is not restricted to only the usage of the capacitive touch panel. In other aspects, the user may also use different types of touch plates 211 (e.g., the resistive touch panel, the ultrasonic touch panel, the optical touch panel or the electromagnetic inductive touch panel) according to the design requirements. The optical touch panel may be an infrared touch panel. Herein, the touch types of the touch plates 211 will not be particularly restricted. In addition, the touch plates 211 may further have a protection layer (not shown in FIG. 3A), which may be made of the glass, resin or any other non-electroconductive material, and is disposed on the touch plates 211 to protect the touch plates 211 from being interfered or damaged by the foreign objects.

The projection device 22 has plural projection units 221, which project the images onto the plane P, formed by the combination of the touch plates 211, and a complete projection image (not shown in FIG. 3A) can be formed on the plane P. The projection unit 221 may be a projector, and the projection image may be a static image or a dynamic image. In addition, the so-called complete projection image represents that each projection unit 221 projects a smaller sub-projection image onto the touch plates 211 but the sub-projection images may be combined and formed into a large-area complete image. For example, as shown in FIG. 3B, four projection units 221 (not shown in FIG. 3B) project four portions of a vehicle (i.e., the sub-projection images PI1 to PI4), respectively, and the four sub-projection images PI1 to PI4 may be combined and formed into a complete projection image PI (a complete vehicle).

It is to be noted that one of the touch plates 211 of the touch projection system 2 of FIG. 3A may have an arbitrary dimension. For the sake of construction and combination, however, the dimensions of the touch plate 211 include a length and a width both equal to 50 cm, and the projection image of one projection device 22 can cover 48 touch plates 211. Of course, the invention is not particularly restricted thereto. The touch projection system 2 does not intend to restrict the number of the touch plates 211 with the specific area, or the number of the projection devices 22 because the number thereof may be determined according to the area of the ground, wall or desktop.

The control module 23 is electrically connected to the touch plates 211 and the projection units 221. The control module 23 can control the projection device 22 to correspondingly change the projection image PI when a user touches the projection image PI on the plane P (the touch plates 211). In other words, when the user touches the projection image PI on the touch plate 211, the touched touch plate 211 can deliver the touch signal, generated according to the touched position, to the control module 23. The control module 23 can control the projection unit(s) 221 (may be one, two or more than two projection units 221) corresponding to the touched position according to the touch signal to change the projection image PI, so that the user feels that the projection image PI is interacting with he or she.

In the following, the control module 23 concurrently controls four projection units 221, so that the projection units 221 project the sub-projection images PI1 to PI4, respectively, to construct the complete projection image PI. Of course, the designer may also use more touch plates 211 and more projection units 221 according to the requirements.

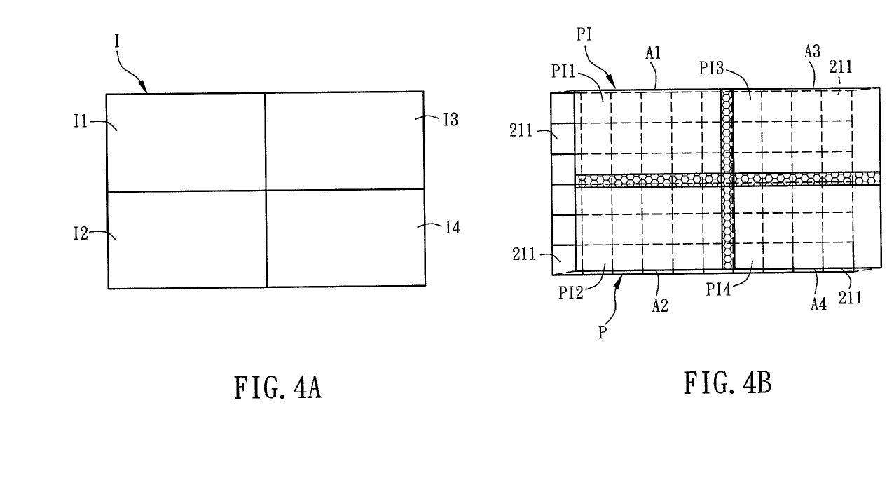

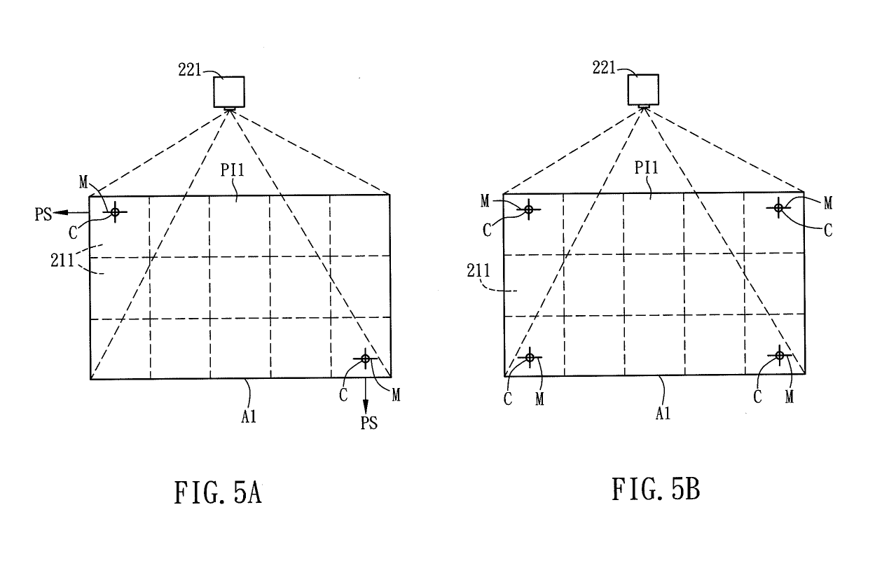

As shown in FIGS. 4A and 4B, the control module 23 firstly divides an image I, to be projected, into plural sub-images I1 to I4. The projection units 221 can project the sub-images I1 to I4 onto the plane P to form projection areas A1 to A4 on the plane P, respectively. The sub-projection images PI1 to PI4 are respectively formed in the projection areas A1 to A4. The projection areas A1 to A4 can cover the plural touch plates 211, respectively. In addition, two neighboring sub-projection images have a partially overlapped image. That is, the projection areas A1 to A4 have partially overlapped regions. In addition, the overlapped portions between two neighboring projection areas of this embodiment occupy 7% to 8% of the projection areas A1 to A4, respectively.

In detail, the control module 23 firstly divides the image I into the plural sub-images I1 to I4, and then delivers the image signals of the plural sub-images I1 to I4 to the corresponding four projection units 221. The four projection units 221 can project the sub-images I1 to I4 onto the projection areas A1 to A4 and form the sub-projection images PI1 to PI4 in the projection areas A1 to A4, respectively, to combine the sub-projection images PI1 to PI4 into the projection image PI.

Nevertheless, it is to be noted that in order to make the projection image PI on the plane P become continuous and smooth, the image fusion technology has to be used to process the overlapped regions between the plural sub-projection images PI1 to PI4 (the overlapped regions between the projection areas A1 to A4, that is, the hatched cruciform region of FIG. 4B) so that the images, colors and brightnesses of the overlapped regions become smooth, and the plural sub-projection images PH to PI4 can be combined into a smooth and complete projection image PI. Therefore, the control module 23 can firstly fuse the overlapped portions between the sub-projection images PI1 to PI4 so that the projection image PI is looked as a smooth complete image.

The positioning and calibrating processes of the invention will be described in detail with reference to the associated drawings. Because the plural touch plates 211 are combined and formed into the large-area plane P, locating and calibrating operations have to be performed between the projection image PI and the plural touch plates 211, so that the correct projection unit 221 can perform the corresponding interaction at the positions of the touch plates 211 touched by the user.

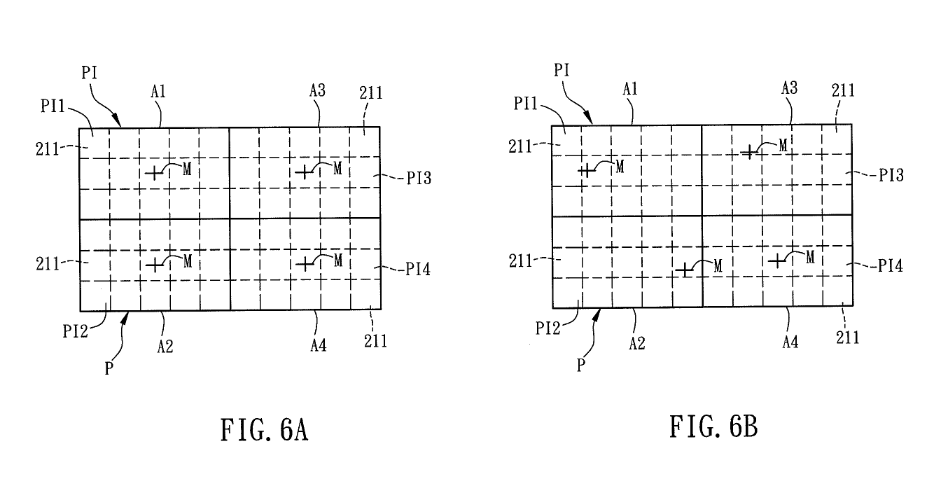

The positioning and calibration method of the invention will be described with reference to FIGS. 2 and 5A. FIG. 5A is a schematic illustration showing the projection unit 221 projecting positioning markers on the projection area A1.

First, in the step S01, the plural positioning markers M are projected onto the plane P by the projection device 22. In this embodiment, the control module 23 (not shown in FIG. 5A) alternately makes one of the projection units 221 project the positioning markers M. In other words, the control module 23 firstly controls the first projection unit 221 to turn on, and to project a positioning marker M in the projection area A1 corresponding to the projection unit 221, so that the positioning and calibration are performed between the sub-projection image PI1 and the touch plates 211 within the projection area A1. Herein, the positioning marker M is a cross marker. Of course, other types of markers may also be adopted. In other words, the control module 23 firstly turns off the other projection units 211, and only turns on the projection unit 221 corresponding to the projection area A1 to project the positioning marker M within the projection area A1. Herein, as shown in FIG. 5A, one positioning marker M is projected onto each of the diagonal corners of the projection area A1. The object of turning off the other projection units 211 is to disable the other projection units 211 from projecting images to cause overlapped regions of images within the projection area A1 and to prevent the positioning and calibration operations from being interfered.

Next, in the step S02, a calibration element C is disposed at or around each of the positioning markers M. Herein, one calibration element C is placed on each positioning marker M. When the calibration element C is in contact with the touch plate 211, the voltage level of the capacitor of the touch plate 211 is changed to generate a positioning signal PS. Then, the control module 23 can receive the positioning signal PS generated by the touch plate 211.

In the step S03, the corresponding projection unit 221 is located and calibrated according to the positioning signal PS of the calibration element C delivered by the touch device 21. In FIG. 5A, two calibration elements C get one positioning signal PS, and the control module 23 can perform the positioning corresponding to the display position of the sub-projection image PI1 according to each positioning signal PS, so that the actual position of the touch plate 211 on the projection area A1 matches with the display position of the sub-projection image PI1, and the corresponding relationship between the projection area A1 and the sub-projection image PH may be established. Therefore, the control module 23 can position the sub-projection image PI1 of the projection unit 211 with the actual position on the touch plates 211 to complete the positioning and calibrating operations between the touch plate 211 of the projection area A1 and the sub-projection image PI1 of the projection unit 221.

Analogically, after the positioning and calibrating operations between the actual position of the touch plate 211 and the display position of the sub-projection images PI2 to PI4 are performed on the other projection areas A2 to A4, the positioning and calibrating operations between the projection images PI and all the touch plates 211 can be completed.

It is to be noted that the calibration element C is a conductor. The object of using the conductor as the calibration element C will be described in the following. Because the sensing principle of the touch plate 211 of the invention is mainly based on the detection of the electric property variation between the to-be-tested object and the touch plate 211. The organism is a grounding conductor with the irregular shape, size and volume, and different users have different properties. Thus, the invention uses the calibration elements C as the grounding metals with the same dimension to ensure the constant reference electrical property. In addition, when the calibration element C is placed on the positioning marker M, the positioning and calibration method may further include the step of grounding the calibration element C. The purpose of grounding is to make the charges on the calibration element C flow to generate the potential difference. In addition, the number of the positioning markers M projected by the projection unit 221 is not restricted to two. As shown in FIG. 5B, one positioning marker M is projected onto each of four corners (or three corners) of the projection area, and one calibration element C is placed on each of the 4 (or 3) positioning markers M. As a result, the calibration based on more calibration elements C enhances the positioning and calibration precision between the projection image PI1 and the touch plate 211.

It is to be noted that the positioning and calibration method is described only as an example, and the user may also perform the positioning and calibration by another method.

For example, as shown in FIG. 6A, the position of the positioning marker M projected by the projection unit 221 is not necessarily to be located at the corner, and the positioning marker M may also be projected at the middle position of the projection area A1, and two or more than two calibration elements C may be disposed around the positioning marker M. Herein, the projection units 221 are turned on concurrently, the projection units 221 project the positioning markers M onto the middle positions of the projection areas A1 to A4 concurrently, and two or more than two calibration elements C (not shown in FIG. 6A) are concurrently placed around the positioning marker M, so that the positioning and calibrating operations between the touch plates 211 in the projection areas A1 to A4 and the projection images PI of the projection units 221 can be completed. Therefore, when there are a lot of projection units 221 (this represents that the area of the ground or wall is relatively large), the positioning and calibrating time can be shortened.

Alternatively, as shown in FIG. 6B, the projection units 221 may also concurrently project the positioning markers M onto the projection areas A1 to A4, respectively, wherein the positioning marker M is not necessarily to be located at the middle position or corner of each of the projection areas A1 to A4. In other words, the positioning markers M respectively projected by the projection units 221 only have to be located within the projection areas A1 to A4. In addition, two or more than two calibration elements C (not shown in FIG. 6B) are concurrently disposed around each positioning marker M, so that the positioning and calibrating operations between the touch plates 211 in the projection areas A1 to A4 and the projection images PI of the projection units 221 can be completed concurrently. Thus, when there are a lot of projection units 221, the positioning and calibrating time can be shortened. It is to be again noted that the number of the projected positioning markers M is not restricted to 4 in FIG. 6B. The positioning and calibrating precision gets higher when more positioning markers M are projected.

Therefore, after the positioning and calibration of the touch projection system 2, when the user contacts the projection image PI of the touch plate 211, the touch plate 211 at the position contacted by the user can generate a touch signal, and the control module 23 receives the touch signal and then controls the projection unit 221 corresponding to the projection device 22 to project another corresponding projection image within the projection area according to the touch signal. Herein, the vehicle of FIG. 3B will still be described as an example. For example, when the user touches a vehicle door handle H of the vehicle, the touch signal generated by the touch plate 211 (not shown in FIG. 3B) at the position of the vehicle door handle H can be delivered to the control module 23 (not shown in FIG. 3B), and the control module 23 can control the projection unit 221 (not shown in FIG. 3), corresponding to the position, to project another projection image according to the touch signal. For example, after the touch, the vehicle door handle H is opened to let the user see the apparatuses inside the vehicle, or see other interacting contents (e.g., let the user see the apparatuses inside the vehicle and play music concurrently). Thus, the projection image can interact with the user.

In summary, the positioning and calibration method according to the invention includes the steps of: projecting plural positioning markers on the plane by the projection device; disposing a calibration element at or around each positioning marker; and locating and calibrating the corresponding projection unit according to a positioning signal of the calibration element delivered by the touch device. Thus, the location can be positioned according to the positioning signal corresponding to the display position of the projection image, so that the actual position of the touch plate on the projection area matches with the display position of the projection image to complete the positioning and calibrating operations. Therefore, the positioning and calibration method of the invention makes a touch projection system, having plural touch plates and plural projection units, have the good location function.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A positioning and calibration method applied in positioning and calibration of a projection system with touch control function, wherein the projection system comprises a touch device and a projection device, the touch device has plural touch plates, the touch plates can be combined and formed into a plane, the projection device has plural projection units, the projection units project images onto projection areas of the plane, respectively, so as to form a projection image on the plane, and the positioning and calibration method comprises the steps of:
projecting plural positioning markers onto the plane by the projection device;
disposing a calibration element at or around each of the positioning markers; and
locating and calibrating the corresponding projection unit according to a positioning signal of the calibration element delivered by the touch device.

2. The method according to claim 1, wherein in the step of projecting the positioning markers, one of the projection units projects the positioning markers alternately.

3. The method according to claim 1, wherein in the step of projecting the positioning markers, the projection units project the positioning markers concurrently.

4. The method according to claim 1, wherein the positioning markers are located at corners of the projection area, respectively.

5. The method according to claim 1, wherein at least one of the positioning markers is located at a middle position of the projection area.

6. The method according to claim 1, wherein the positioning markers are located at middle positions of the projection areas, respectively.

7. The method according to claim 1, wherein the positioning markers are located within the projection areas, respectively.

8. The method according to claim 1, further comprising the step of:
grounding the calibration element.

9. The method according to claim 1, wherein the calibration element is a metal conductor.

10. The method according to claim 1, wherein the touch plates may be combined on a ground, a wall or a desktop to form the plane.
